(19) United States
(12) Patent Application Publication
(10) Pub. No.: US 2002/0124882 A1
(43) Pub. Date: Sep. 12, 2002

(54) Snap valve with shipping pad

(76) Inventor: Thomas Louis Russo, Rutland, VT (US)

Correspondence Address: Thomas Louis Russo, 7 Avenue D, Rutland, VT, 05701, US

(21) Appl. No.: 09/803,170

(22) Filed: Mar. 12, 2001

(51) Int. Cl. F16K 15/20

(52) U.S. Cl. 137/223

(57) ABSTRACT

Snap Valve with Shipping Pad provides a reusable inflatable packaging system. The Snap Valve is a simple valve frame with a gate film that allows airflow through the valve frame and an air chamber that allows the connection of several valve frames to create an exceptionally secure valve in a simple and efficient design. This system allows the shipping pad to be inflated to accommodate a range of fill sizes with the same pad design.

### BACKGROUND OF INVENTION

This invention relates to a reusable packing system with the benefit of an inflatable shipping pad and a Snap Valve format. System has two separate zones in each shipping pad, FIG. 14, with separate controlling Snap Valves, FIG. 19. This allows for additional protection from accidental deflation throughout the shipping process. A single Snap 2 Vale can control two separate zones, FIG. 16 allowing for two zone protection with a reduced manufacturing effort. With its ability to be inflated to different sizes from a deflated size of one eight of an inch, FIG. 14, high to fully inflated to a thickness of three inches high, FIG. 15, this ability to provide 24 times more volume or a range of any point in that sizing creates a flexible system. Shipping pads produced in standard sizes allow for efficient production, FIG. 15. Shipping pads can be manufactured in a variety of shapes and sizes, FIG. 16 providing a custom system for many category needs. The ability to be inflated or deflated, FIG. 9, FIG. 9b, as the task requires provides a reusable system for all users in a shipping cycle. This shipping program can be stored deflated reducing storage requirements. If an eight cubic foot shipping carton is used to ship an item or inner pack of six cubic feet the following solutions to support the item or inner pack in the center of the shipping carton. If foam beans are used this package will require 4.68 cubic feet of shipping beans. If the same package was completely surrounded with snap valve shipping pads, FIG. 21, it would require 12 pads, deflated these pads are only one third of a cubic foot. Inflated they can provide six cubic feet of fill. If you were packing 50 boxes of this size a day for five days a week, with the foam bean system you would need to store 1170 cubic feet of bean packing material if you kept one months supply on hand you would need storage space for 4680 cubic feet of beans. The Snap valve shipping system would require 78 cubic feet for the five day period or 312.5 cubic feet of storage for the deflated pads for a month worth of shipping fill.

This would represent an approximate saving of storage space of 93%. This same space would represent the savings of disposal space used up if these shipping pads were not recycled. These shipping pads can be folded, FIG. 23, placed in the shipping carton then inflated to provide a six inch wide or 48 times its original deflated size. This system is developed around a simple valve with no mechanical moving interior parts. The valve system consists of a valve frame FIG. 1, with its gate film FIG. 1 (6), that allows air to move through the valve frame, FIG. 8, and an air chamber film FIG. 4 (11,11b) that allows several valve frames to be attached in a bellows format to provider greater security against valve leakage during shipping. The air chamber can also be created by the walls of a handle assembly FIG. 17 (19), (18). Reducing manufacturing effort, with reduce valve security. The valve design is snapped apart, FIG. 1d, FIG. 7, FIG. 8, to allow air to flow through the valve frames through the air chamber and into the shipping pad zone, once filled snap the valve frames together FIG. 5, FIG. 6, FIG. 9 to secure inflated zone for shipping. Snap valves can be made up of two valve frames Snap2 FIG. 10, FIG. 11, FIG. 12, FIG. 13, or Three snap valve frames can be used for additional valve security, FIG. 4, FIG. 5, FIG. 6, FIG. 7, FIG. 8, FIG. 9.

This valve system can be deflated by snapping open the valve frames, FIG. 9b, and inserting a tube that will open the gate film on each valve frame and allow air to escape. This system of Snap valve and shipping pad requires no special equipment to operate. Pads can be filled by mouth or with compressed air, FIG. 7(29). And can be deflated with a common household straw. Allowing the end user to store, reuse and recycle this packing fill.

This Snap Valve shipping pad can be printed with a logo inside and out, to provide marketing opportunity well after the goods are received. Packing fill that can advertise a company's direction to conserve energy and recycle. The snap valve itself can be used in various other applications where air containment for simple inflation is required.

### SUMMARY OF THE INVENTION

The invention is designed to meet the above requirements and provide a simple and flexible packing system with reusable pad and snap valve system.

For a better understanding of the structure of the invention and its function, further explanation is given below with reference to the attached drawings.

### BRIEF DESCRIPTION OF THE DRAWINGS

FIG. 1 section through view of a snap valve frame (1) front of valve frame body, (2) air portal provides and entrance and an exit for air flow through the valve frame, (3) snap ridge surrounds the valve frame front and provides the snap lock between two valve frames, (4) air chamber film ridge helps to secure air chamber film when snap valve is closed, (5) gate film hinge groove that provides a recessed area for silicone sealant that secures the gate film at the top of the gate film in the frame valve body, (6) gate film controls the movement of air flow through the valve body, (7) valve frame back supports the entrance for the snap lock of a second snap valve body, (8) snap groove provides the locking area for a second snap frame, (9) air chamber film groove provides additional locking of the air chamber when the valve is closed against another valve, (10) Valve frame snap edge, to assist in pulling the valves open FIG. 1b shows the gate film in a closed position. FIG. 1c shows the gate film in and open position. FIG. 1d Illustrates a SNAP3 Valve in an open position receiving air.

FIG. 2 view of snap valve frame from the back looking down on the valve exit (2) air portal provides and entrance and an exit for air flow through the valve frame, (5) gate film hinge groove that provides a recessed area for silicone sealant that secures the gate film at the top of the gate film in the frame valve body, (8) snap groove provides the locking area for a second snap frame, (9) air chamber film groove provides additional locking of the air chamber when the valve is closed against another valve, (10) Valve frame snap edge, to assist in pulling the valves open

FIG. 3 View of snap valve frame from the front looking up at the valve entrance, 1) front of valve frame body, (2) air portal provides and entrance and an exit for air flow through the valve frame, (3) snap ridge surrounds the valve frame front and provides the snap lock between two valve frames, (4) air chamber film ridge helps to secure air chamber film when snap valve is closed, (10) Valve frame snap edge, to assist in pulling the valves open

FIG. 4 view of three snap valve frames with their air chamber film heat welded to the back edge of each valve frame. The valve is created by the valve frame FIG. 1 and the air chamber that is created when two valves are heat welded together around their chamber film. (3) snap ridge surrounds the valve frame front and provides the snap lock between two valve frames, (7) valve frame back supports the entrance for the snap lock of a second snap valve body, (8) snap groove provides the locking area for a second snap frame, (11) forward air chamber film creates the front half of the air chamber between valves, (11b) rear air chamber film creates the back half of the air chamber between valves, (12) heat welded seam around the air chamber film creating the valve frame to valve frame air tight connection

FIG. 4b perspective view of complete Snap3 valve in open position(2) air portal provides and entrance and an exit for air flow through the valve frame, (3) snap ridge surrounds the valve frame front and provides the snap lock between two valve frames, (4) air chamber film ridge helps to secure air chamber film when snap valve is closed, (11) forward air chamber film creates the front half of the air chamber between valves, (11b) rear air chamber film creates the back half of the air chamber between valves, (12) heat welded seam around the air chamber film creating the valve frame to valve frame air tight connection

FIG. 5 perspective view of complete Snap3 valve in closed position(2) air portal provides and entrance and an exit for air flow through the valve frame, (3) snap ridge surrounds the valve frame front and provides the snap lock between two valve frames, (4) air chamber film ridge helps to secure air chamber film when snap valve is closed, (11) forward air chamber film creates the front half of the air chamber between valves, (11b) rear air chamber film creates the back half of the air chamber between valves, (12) heat welded seam around the air chamber film creating the valve frame to valve frame air tight connection

FIG. 6 profile view of complete Snap3 valve in closed position illustrating the snap valve interlocking with the valve frame in the forward position, stopping the air flow (1) front of valve frame body, (3) snap ridge surrounds the valve frame front and provides the snap lock between two valve frames, (4) air chamber film ridge helps to secure air chamber film when snap valve is closed, (11) forward air chamber film creates the front half of the air chamber between valves, (11b) rear air chamber film creates the back half of the air chamber between valves

FIG. 7 profile view of complete Snap3 valve in open position illustrating the snap valve separated from the valve frame in the forward position, allowing the air flow (3) snap ridge surrounds the valve frame front and provides the snap lock between two valve frames, (4) air chamber film ridge helps to secure air chamber film when snap valve is closed, (10) Valve frame snap edge, to assist in pulling the valves open, (11) forward air chamber film creates the front half of the air chamber between valves, (11b) rear air chamber film creates the back half of the air chamber between valves. Air can be provides by a compressed air system (29) or by a forceful breath by mouth.

FIG. 8 section through view of complete Snap3 valve in open position illustrating the snap valve separated from the valve frame in the forward position, allowing the air flow through each gate film (6) in each valve frame. (1) front of valve frame body, (2) air portal provides and entrance and an exit for air flow through the valve frame, (3) snap ridge surrounds the valve frame front and provides the snap lock between two valve frames, (4) air chamber film ridge helps to secure air chamber film when snap valve is closed, (6) gate film controls the movement of air flow through the valve body, (7) valve frame back supports the entrance for the snap lock of a second snap valve body, (8) snap groove provides the locking area for a second snap frame, (9) air chamber film groove provides additional locking of the air chamber when the valve is closed against another valve, (11) forward air chamber film creates the front half of the air chamber between valves, (11b) rear air chamber film creates the back half of the air chamber between valves, (12) heat welded seam around the air chamber film creating the valve frame to valve frame air tight connection

FIG. 9 section through view of complete Snap3 valve in closed position illustrating the snap valve interlocking with the valve frame in the forward position, stopping the air flow at each valve frame gate film (6),(1) front of valve frame body, (2) air portal provides and entrance and an exit for air flow through the valve frame, (3) snap ridge surrounds the valve frame front and provides the snap lock between two valve frames, (6) gate film controls the movement of air flow through the valve body, (7) valve frame back supports the entrance for the snap lock of a second snap valve body, (8) snap groove provides the locking area for a second snap frame, (9) air chamber film groove provides additional locking of the air chamber when the valve is closed against another valve, (10) Valve frame snap edge, to assist in pulling the valves open, (11) forward air chamber film creates the front half of the air chamber between valves, (11b) rear air chamber film creates the back half of the air chamber between valves, (12) heat welded seam around the air chamber film creating the valve frame to valve frame air tight connection

FIG. 9b illustrates the Snap3 valve in the open position in order to deflate the inflated item controlled by the snap valve. A deflation tube (13) opens each of the valve gate films and allows the air to escape and deflates the item.

FIG. 10 perspective view of complete Snap2 valve in open position, (1) front of valve frame body, (2) air portal provides and entrance and an exit for air flow through the valve frame, (3) snap ridge surrounds the valve frame front and provides the snap lock between two valve frames, (4) air chamber film ridge helps to secure air chamber film when snap valve is closed, (10) Valve frame snap edge, to assist in pulling the valves open, (11) forward air chamber film creates the front half of the air chamber between valves, (11b) rear air chamber film creates the back half of the air chamber between valves, (12) heat welded seam around the air chamber film creating the valve frame to valve frame air tight connection

FIG. 11 profile view of complete Snap2 valve in closed position illustrating the snap valve interlocking with the valve frame in the forward position, stopping the air flow (1) front of valve frame body, (2) air portal provides and entrance and an exit for air flow through the valve frame, (3) snap ridge surrounds the valve frame front and provides the snap lock between two valve frames, (4) air chamber film ridge helps to secure air chamber film when snap valve is closed, (7) valve frame back supports the entrance for the snap lock of a second snap valve body, (9) air chamber film groove provides additional locking of the air chamber when the valve is closed against another valve, (11) forward air chamber film creates the front half of the air chamber between valves, (11b) rear air chamber film creates the back half of the air chamber between valves, (12) heat welded seam around the air chamber film creating the valve frame to valve frame air tight connection

FIG. 12 section through view of Snap2 Valve in the closed position, illustrating the same closure protocol of the Snap3 Valve, the first gate film is held securely closed by the snap lock action of the second valve frame against it.

FIG. 13 section through view of Snap2 Valve in the open position Illustrating a simple but secure valve movement.

FIG. 14 Perspective view . . . Deflated Shipping Pad Shipping Pad provides two separate zones of inflatable air chambers. Zone one (14) is controlled by a Snap Valve in filler pocket (16). Valves are separated by open space creating a handle for storage (18) and zone two air chambers (15) are controlled by a Snap Valve connected to a filler pocket at position (17). Pad is developed in a simple system geometric layout is heat welded into film rolled materials.

FIG. 15 Perspective view . . . Inflated Shipping Pad. Shipping Pad provides two separate zones of inflatable air chambers. Zone one (14) is controlled by a Snap Valve in filler pocket (16). Valves are separated by open space creating a handle for storage (18) and zone two air chambers (15) are controlled by a Snap Valve connected to a filler pocket at position (17). Pad is developed in a simple system geometric layout is heat welded into film rolled materials.

FIG. 15b presents the filler pockets without any valves to better illustrate the design layout. Snap Valves are placed in the shipping pad filler pockets (16) and (17) during the fabrication process prior to heat sealing the cone layout with handle and filler pockets.

FIG. 15c shows the Snap3 Valve that could be used in a filler pocket.

FIG. 16 Perspective view of deflated shipping pad Shipping Pad provides two separate zones of inflatable air chambers. Zone one (14) and zone two air chambers (15) are controlled by a Snap Valve 2 in filler pocket (16). Valves are separated by open space created in the handle by adding a third level of zone film (18). The valve air chamber is created in the handle and is part of the handle. Pad is developed in a simple system geometric layout is heat welded into film rolled materials.

FIG. 17 Close-up Perspective view of inflated shipping pad handle assembly Shipping Pad provides two separate zones of inflatable air chambers. Zone one (14) and zone two air chambers (15) are controlled by a Snap 2 Valve in filler pocket, (17) two valve frames are positioned above each other in separate zone levels (16). Valves are separated by open space created in the handle by adding a third level of zone film (18), (19). The valve air chamber is created in the handle and is part of the handle, by heat welding the center film to the top of the right side of the handle (18) and heat welding to the bottom layer of film on the left side (19) creating and air chamber for each zone controlled by one snap 2 valve (17).

FIG. 18 Section through view of inflated shipping pad handle assembly Shipping Pad provides two separate zones of inflatable air chambers. Zone one (14) and zone two air chambers (15) are controlled by a Snap 2 Valve in filler pocket, (17) two valve frames are positioned above each other in separate zone levels (16). Valves are separated by open space created in the handle by adding a third level of zone film (18), (19). The valve air chamber is created in the handle and is part of the handle, by heat welding the center film to the top of the right side of the handle (18) and heat welding to the bottom layer of film on the left side (19) creating and air chamber for each zone controlled by one snap 2 valve (17). Valve frame bodies can be attached at the top of the valve body (20) allowing both valves to be in the handle assembly

FIG. 19 Section through view of inflated shipping pad handle assembly Shipping Pad provides two separate zones of inflatable air chambers. Zone one (14) and zone two air chambers (15) are controlled by a Snap 2 Valve in filler pocket, (17) two valve frames are positioned above each other in separate zone levels (16). Valves are separated by open space created in the handle by adding a third level of zone film (18), (19). The valve air chamber is created in the handle and is part of the handle, by heat welding the center film to the top of the right side of the handle (18) and heat welding to the bottom layer of film on the left side (19) creating and air chamber for each zone controlled by one snap 2 valve (17). Valve frame bodies can be attached at the bottom of the valve body (21) allowing one valve to be in the handle assembly

FIG. 20 close up of zone one (14) and zone two (15) filler pockets (16) separated by the handle cutout (18) with a profile view of a Snap3 valve in a closed position zone one waiting to be secured to the filler pocket with a fourth snap frame without a gate film (19). Zone two is secured with a fourth snap frame heat welded and sealed to the first valve frame of the Snap3 Valve assembly.

FIG. 21 Shipping Pads can be placed in many configurations to completely support interior items (31) in a shipping carton (30). They can be placed in each corner (33) and around the sides of the interior item(31). Shipping pads can be folded to wrap the bottom (32) and top (34) of the interior items.

FIG. 22 smaller shipping carton (30) with a smaller interior item (31) can be completely supported with just a corner (33) configuration that wraps from the bottom to the top of the interior item

FIG. 23 shipping pads can be folded then inflated in packaging to filler wider spaces with the same pad design Zone one (14) and zone two (15), Air pockets (16) that contain a Snap Valve assembly that support each zone, separated by a handle cutout (18)

### DESCRIPTION OF PREFERRED EMBODIMENTS

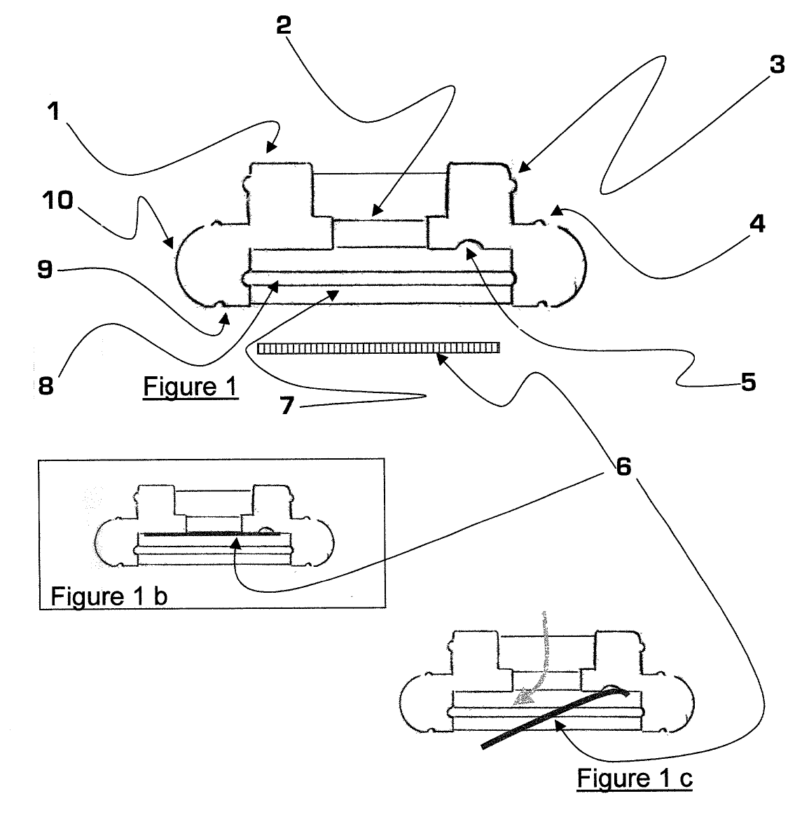

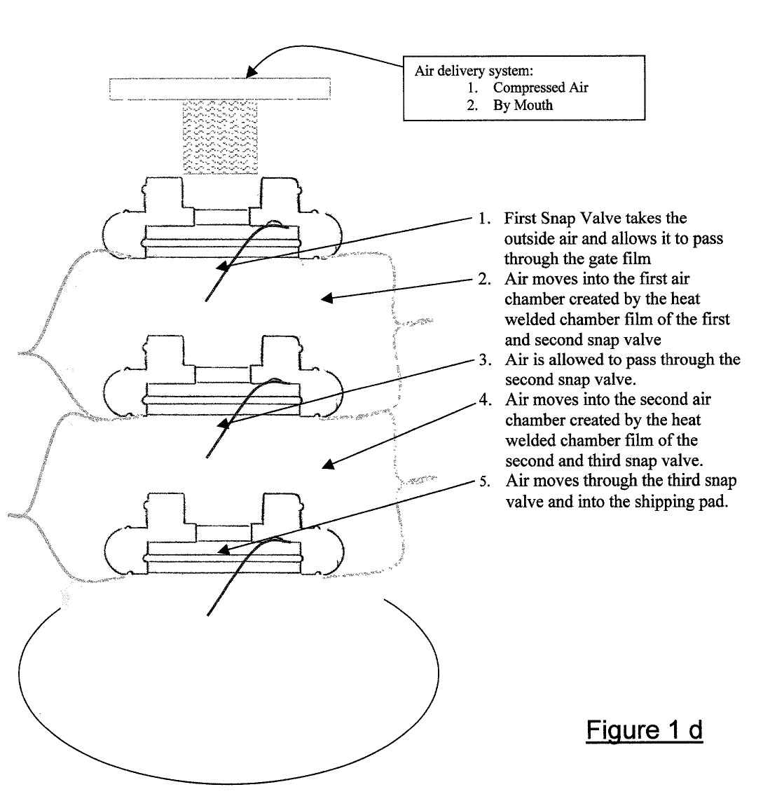

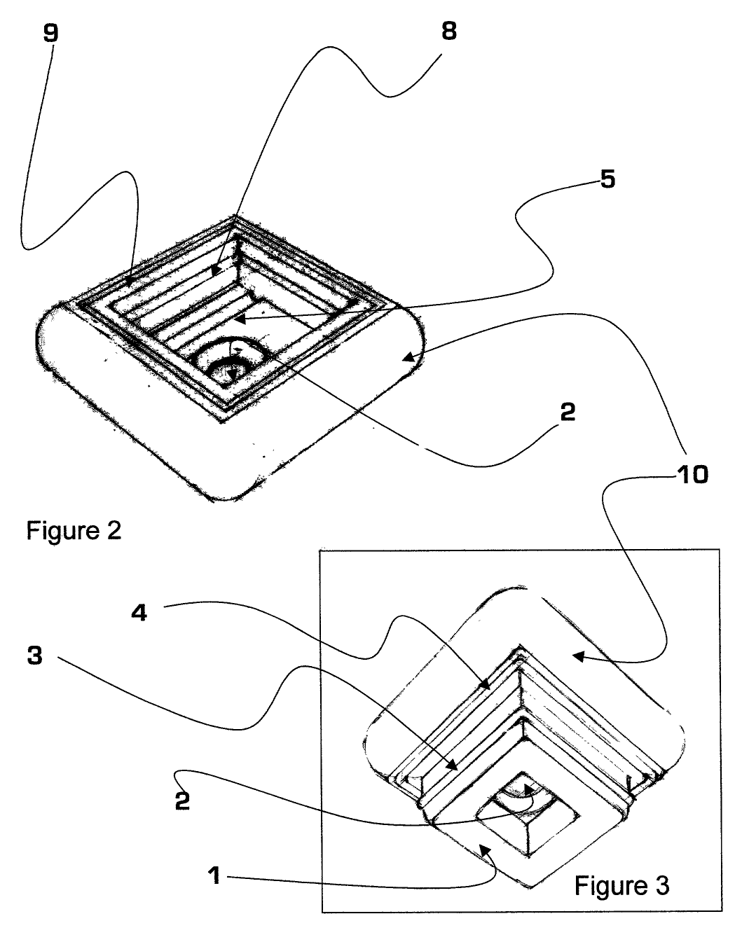

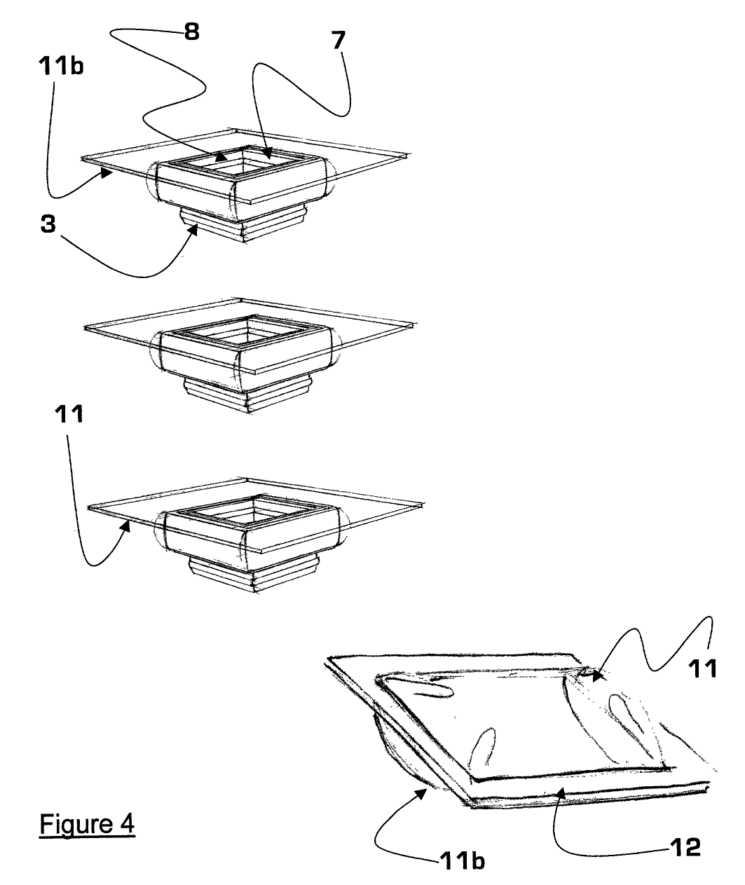

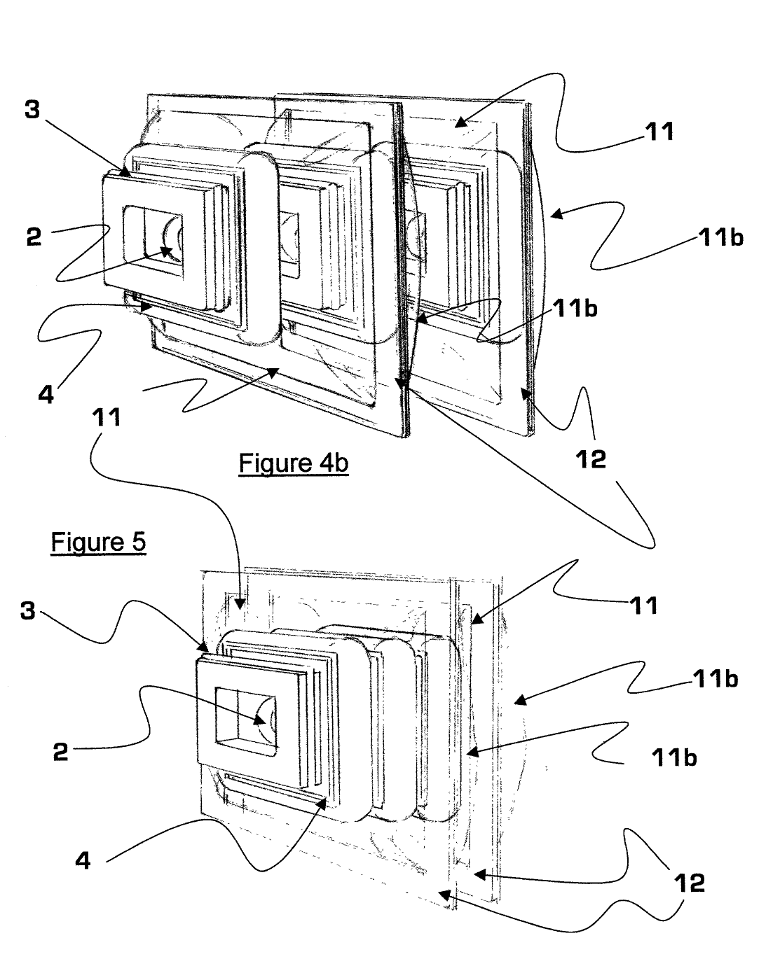

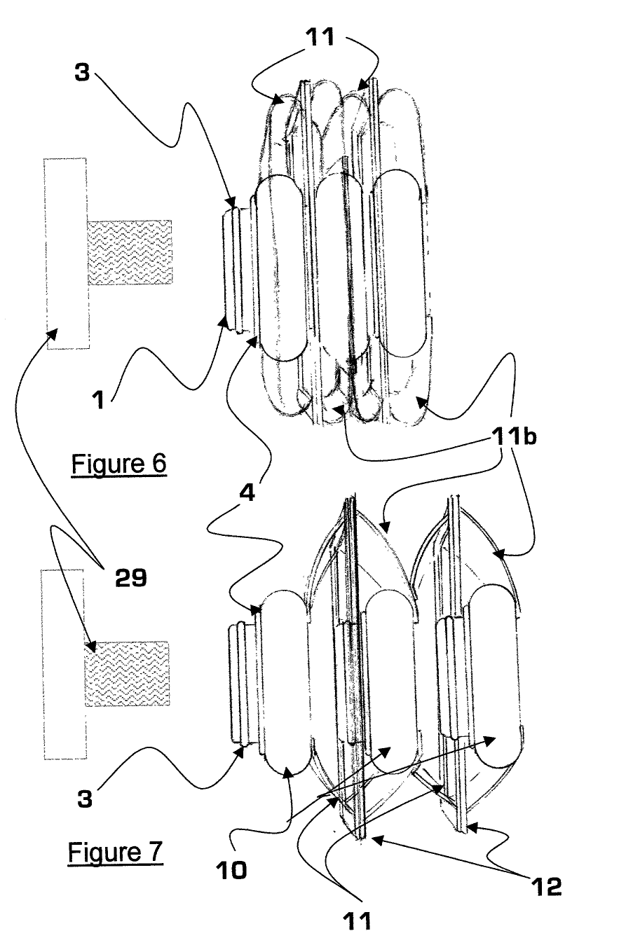

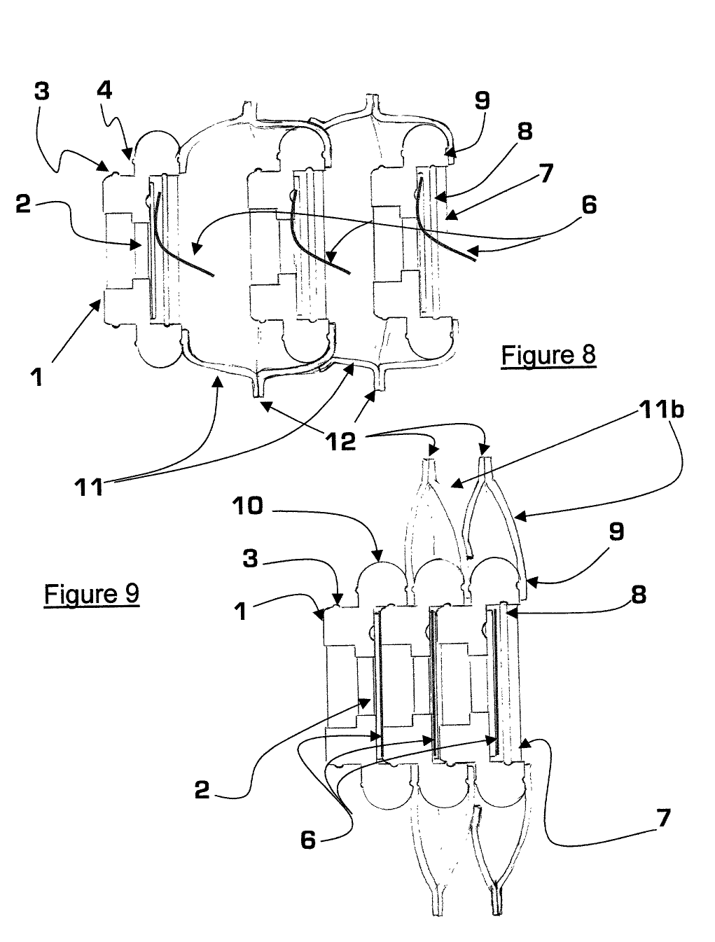

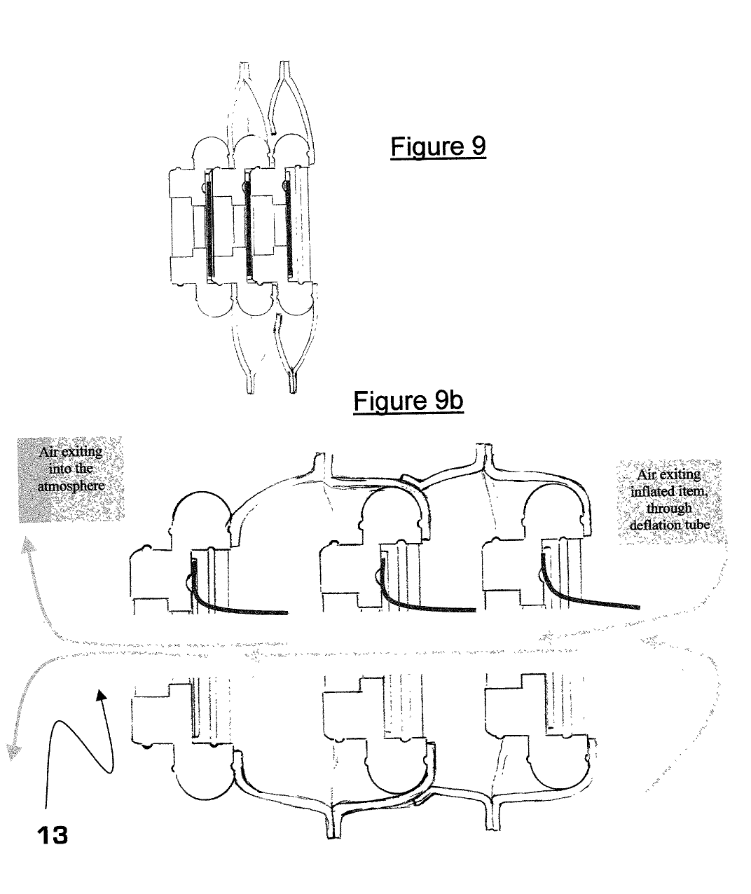

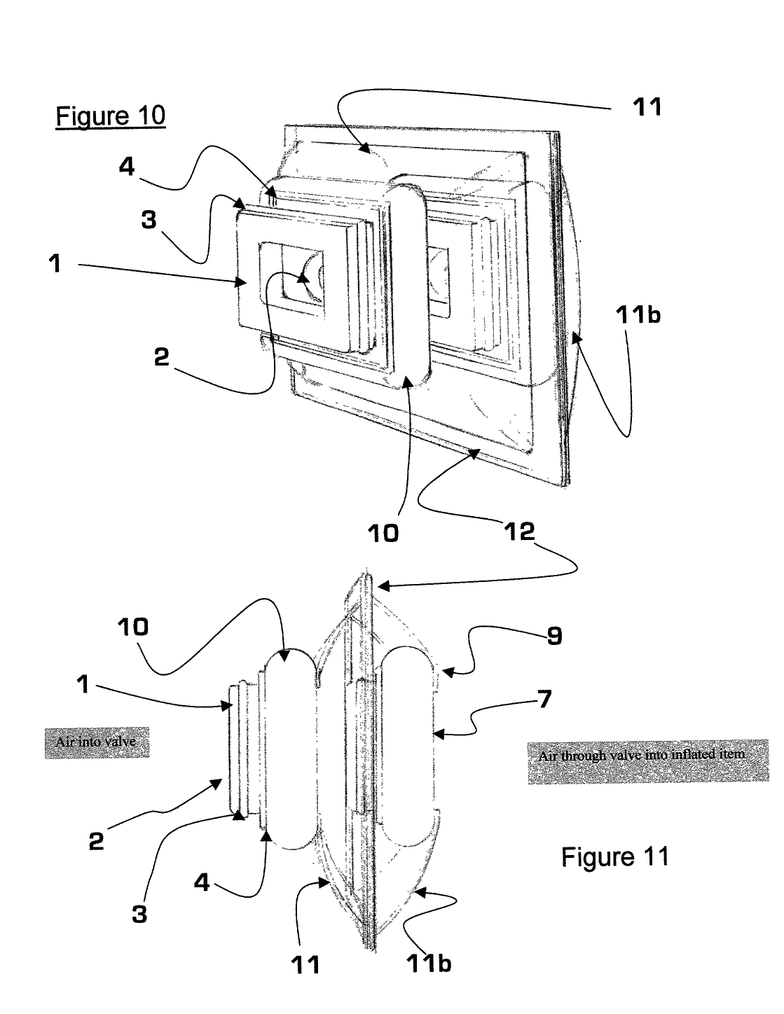

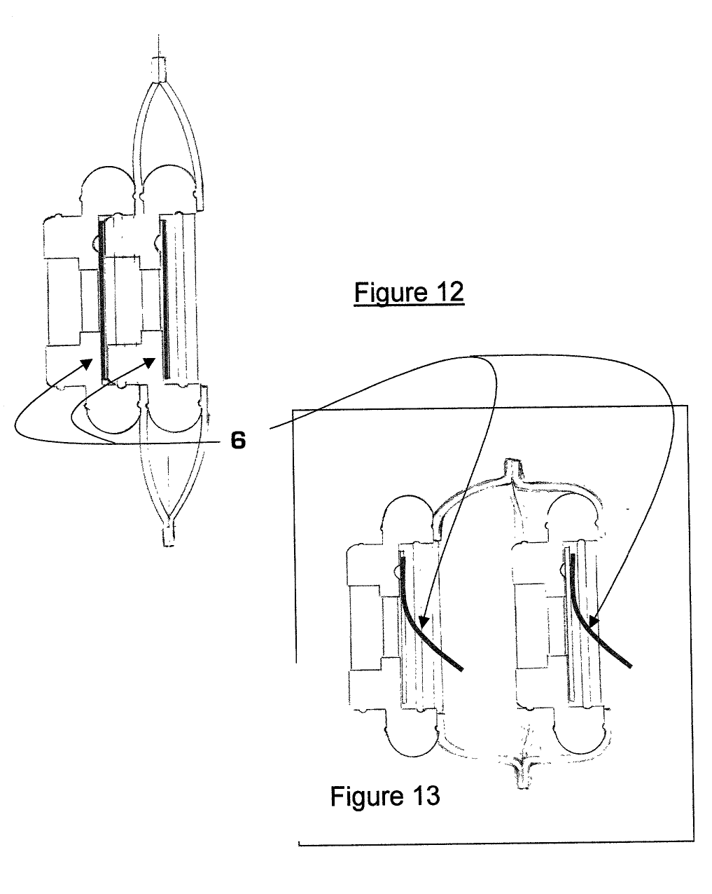

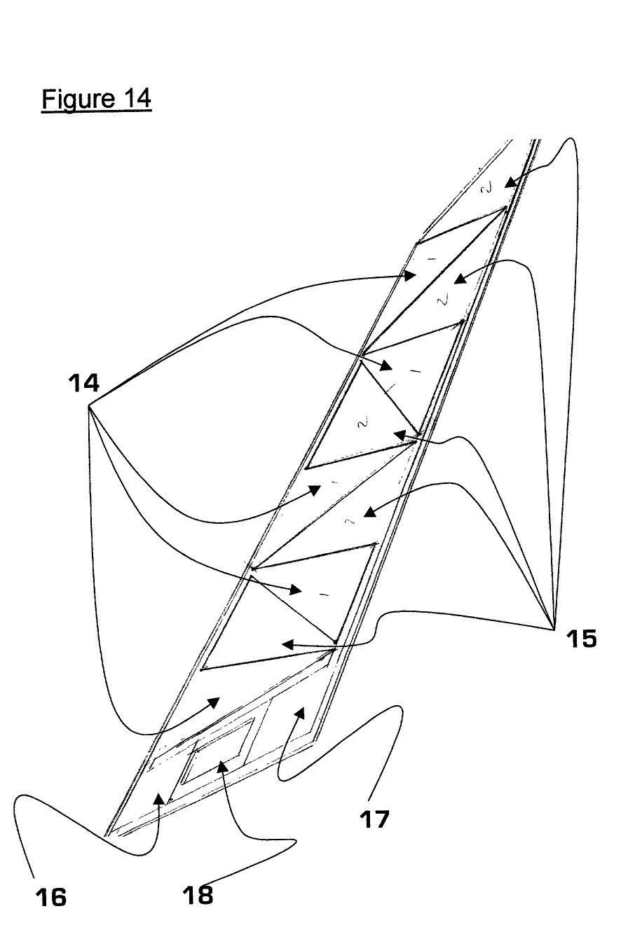

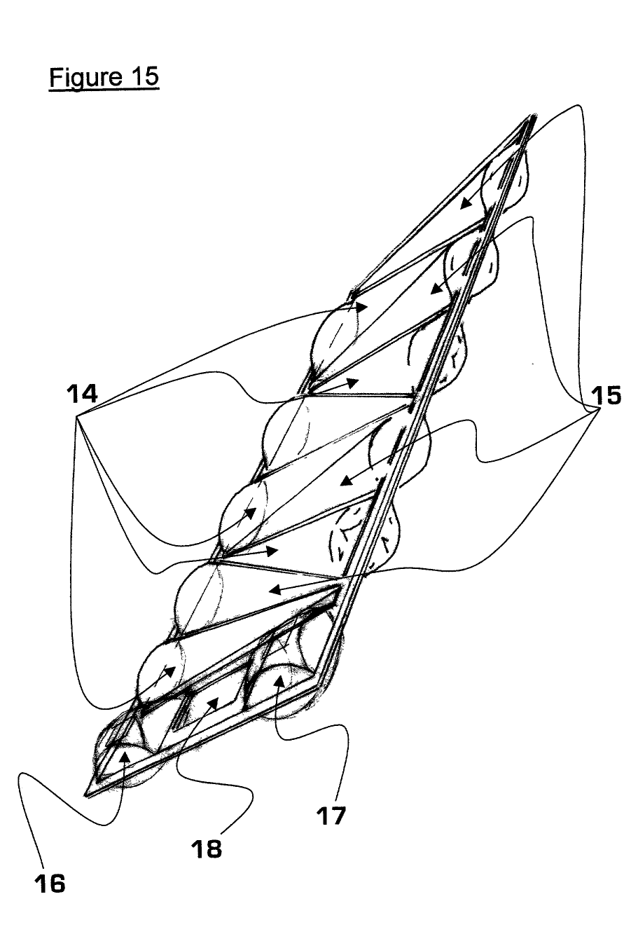

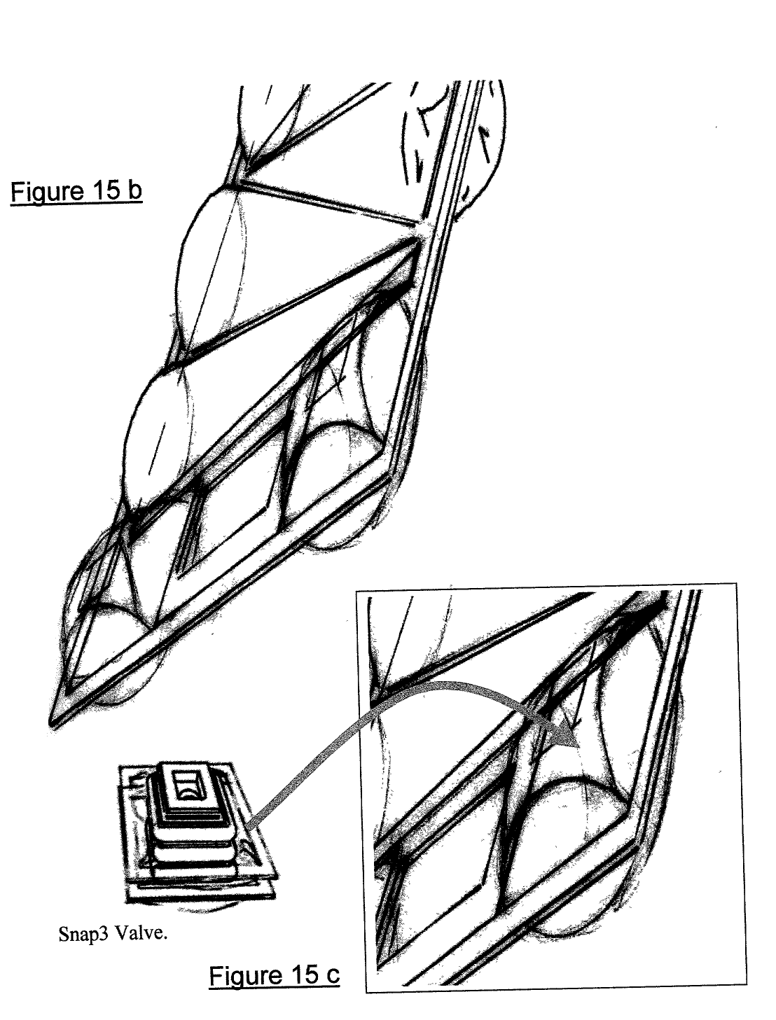

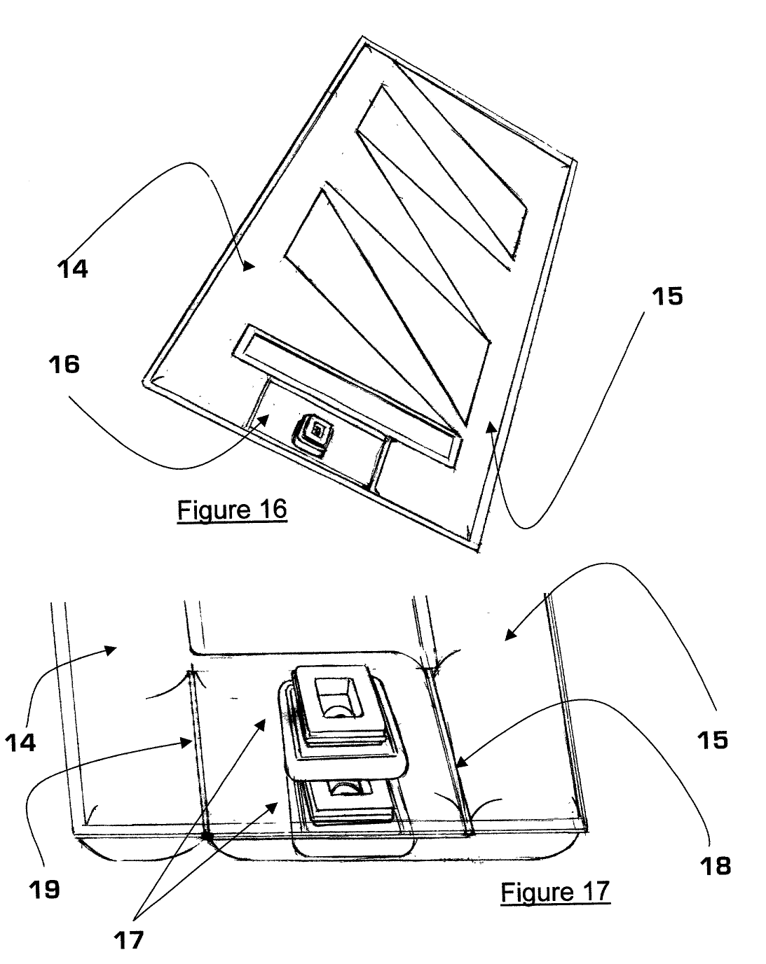

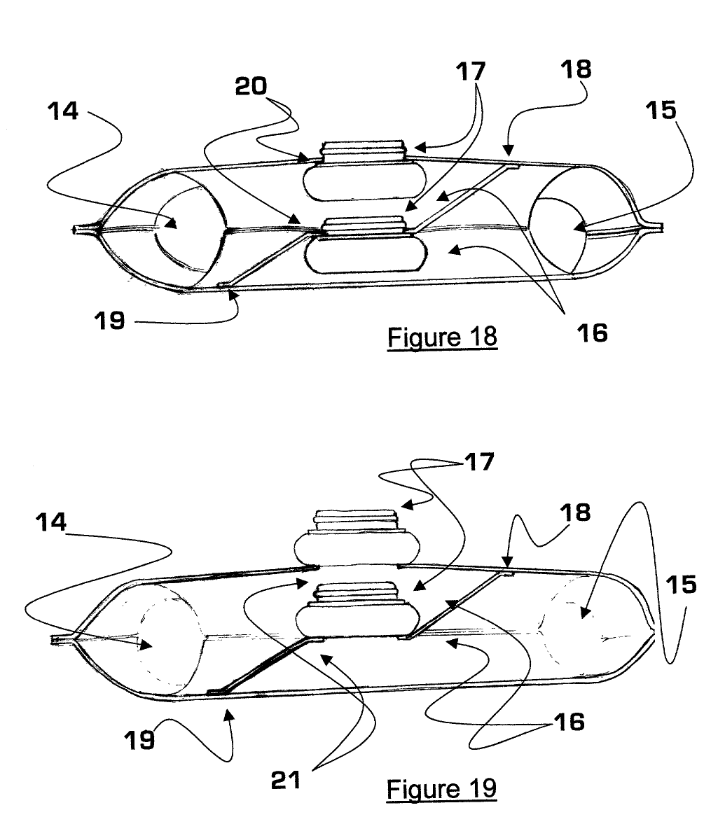

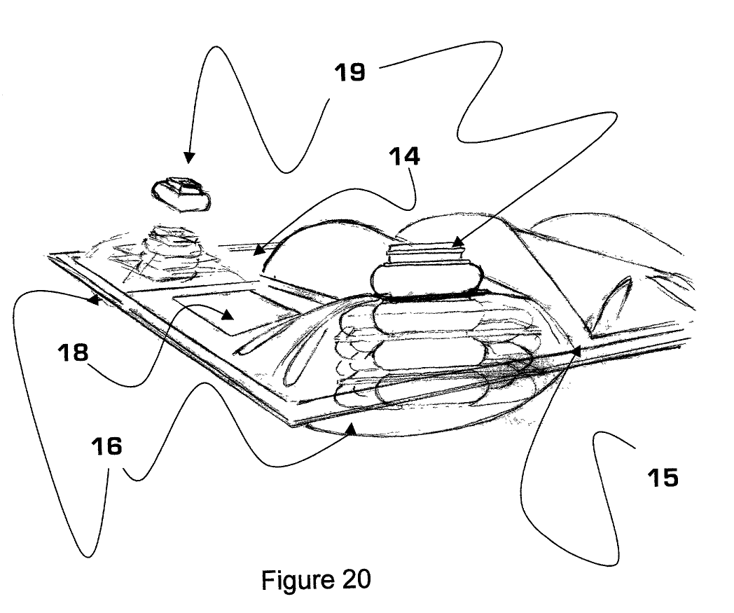

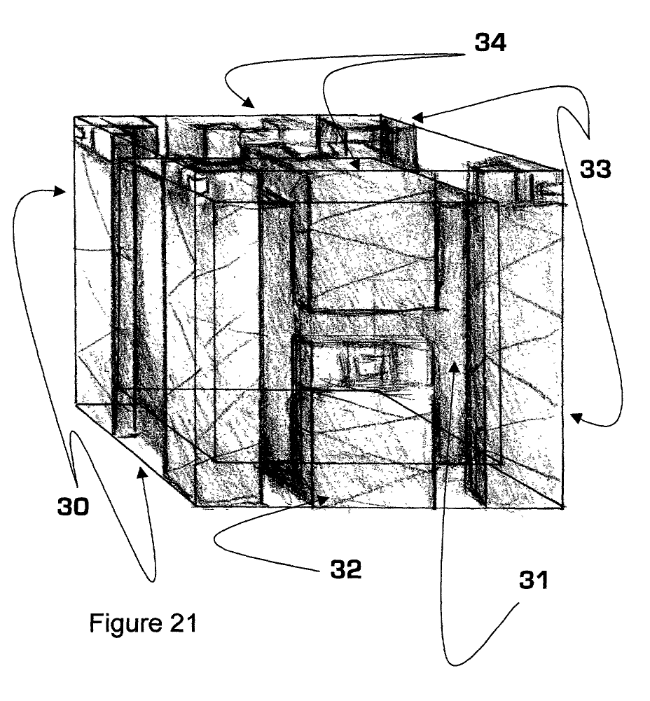

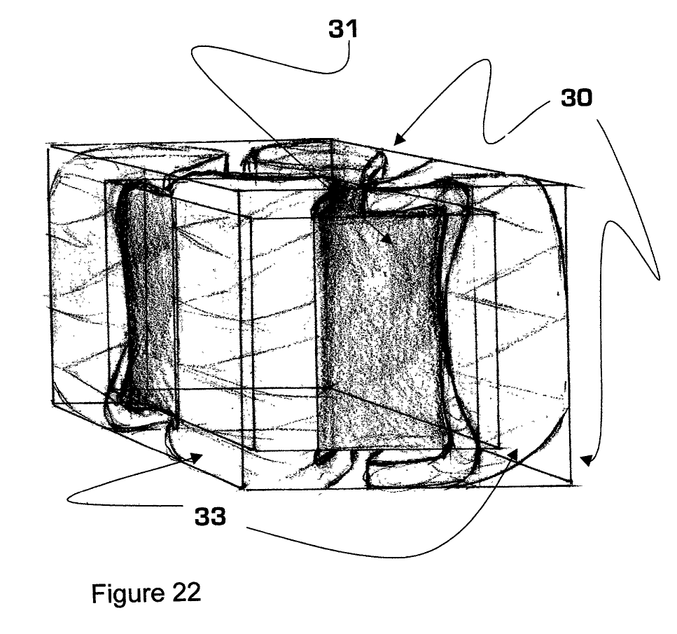

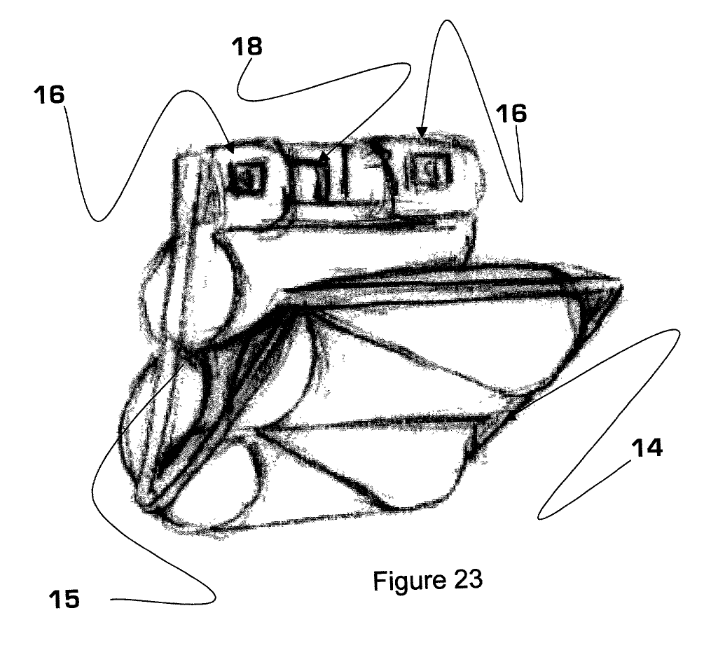

As shown in FIG. 16, our Snap Valve and shipping pad system is everything you need to provide an inflatable, deflatable, reusable packing material. The shipping pad is designed to hold an item or inner package secure in a exterior shipping carton. The shipping pad provides two zones for inflation, FIG. 14, FIG. 15, FIG. 16, adding security to interior package support. The pad is developed by placing two film layers together and heat welding a design, FIG. 14 geometric design that provides a balanced height ratio in each zone. If a zone is punctured this geometric design will allow the second zone to continue to support the interior package. The wide backs of a cone design and the sharp points of each cone are positioned to provide a balance of wide backs from zone one and zone two on each side of a shipping pad, FIG. 14, FIG. 15, FIG. 16. Shipping pads can be placed on each corner, FIG. 21(33) on the interior package and then inflated, holding the interior package from moving back and forth. Shipping pads can be placed on the bottom of the exterior carton the interior package can be lowered on two, FIG. 21(32), or four shipping pads, inflate pads as they surround each side. Place shipping pads down each side of the interior package and inflate, FIG. 21(34), and fold in each of the pads to prevent the interior package from moving up and down during shipping. For smaller lighter interior packages surrounding each corner, FIG. 22 (30) can provide support for both the up and down movement and the side to side movement, with only four properly sized shipping pads. Holding and interior package in place is the result of our shipping pad format. Holding the air in each zone in each pad is the result of a snap valve, FIG. 1. The snap valve will provide an entry, a locking feature, and a release position for the air contained in a shipping pad. The demand on design is a simple structure, with few if any moving parts easy to manufacture and assemble providing an acceptable substitute for current low cost packing materials. The snap valve supplies the entry air to inflate a shipping pad and to improve reusability and air exit to deflate each shipping pad. Snap valve consist of a frame body, FIG. 3, a gate film, FIG. 1 (6), an air chamber, FIG. 4b (11)(11b), FIG. 16(16). The snap valve frame body can be constructed of a moldable soft plastic material that will maintain shape and provide the proper snap lock flexing. In the snap valve frame is an air portal FIG. 1(2) allowing air movement through each valve, a snap ridge, FIG. 1 (3) that snaps a valve frame into another frame body's snap groove, FIG. 1 (8) closing a valve. Gate film, FIG. 1(6), cut of acetate material is held in position with a silicone bead acting as the gate film hinge. This gate film, FIG. 1 (6), allows the air movement through each valve body, through the air portal, FIG. 1(2) A minimum of two snap valve frames are used to create a snap valve, FIG. 10, FIG. 11. An air chamber, FIG. 4 (11)(11b)(12). made of a packing film material connects each valve frame in a valve, FIG. 10(11)(11B), FIG. 11(11)(11b), allowing controlled air movement from one valve body to the next in line. Valves can also be connected by creating an air chamber in a shipping pad handle, FIG. 16 (16), FIG. 17. Snap Valve allow each zone a control on air movement. Valve frames grouped together FIG. 10, FIG. 7. can be manufacture separately creating a complete snap valve. A complete Snap valve can be installed in shipping pads during assembly. Valves frames positioned in a shipping pad handle, FIG. 16, need to be assembled during pad assembly. After the handle is assembled you have a snap valve, FIG. 17. Shipping pads with separate valve pockets, FIG. 14, can aid in quickly filling and deflating a zone, and add a level of valve integrity. Snap 3 valves provide an additional valve frame between the exterior and interior valve frame, FIG. 7. During shipping this complete valve assembly, FIG. 7, floats in a zone air pocket, increasing its ability to withstand rough handling. It would require all three valve bodies to be snapped open, in order for the total shipping pad failure through a breached snap valve. Snap2 Valves provide one less valve body, FIG. 10. to maintain zone protection. Snap2 Valve bodies installed in a shipping pad handle, FIG. 16, FIG. 17, FIG. 18, without additional air chambers, do not float in an air pocket, reducing its ability to withstand rough handling. Snap Valve formats with shipping pads provide a very flexible reusable shipping packing material system.

I claim The snap valve with shipping pad will provide a reusable inflatable shipping fill system with two separate zones of air chambers in each pad for additional protection during shipping.

1. Snap valve will allow the system to be inflated without any special equipment.

2. Snap Valve provides redundant interior valve integrity.

3. Snap Valve allows the shipping pad to be deflated.

4. Snap Valve allows the shipping pad to be reused

5. Shipping Pad has two separate air chamber zones each controlled by a separate Snap Valve.

6. Shipping Pad when deflated reduces storage space

7. Shipping pad will fit many applications and provide a custom fit from a standard format.

8. Shipping pad can be printed with company logo for added marketing value.
